(19) United States
(12) Patent Application Publication
(10) Pub. No.: US 2025/0145741 A1
(43) Pub. Date: May 8, 2025

(54) FUNCTIONALIZED POLYMERS

(71) Applicant: ARLANXEO DEUTSCHLAND GMBH, Dormagen (DE)

(72) Inventors: Kilian Nikolaus Richard WUEST, Dormagen (DE); Christoph HAHN, Mainz (DE); Holger FREY, Mainz (DE)

(73) Assignee: ARLANXEO DEUTSCHLAND GMBH, Dormagen (DE)

(21) Appl. No.: 18/684,319

(22) PCT Filed: Aug. 15, 2022
(86) PCT No.: PCT/EP2022/072780

§ 371 Date: Feb. 16, 2024

(30) Foreign Application Priority Data
Aug. 17, 2021 (EP) 21191789.3

(51) Int. Cl. C08F 8/12

(52) U.S. Cl. CPC C08F 8/12

(57) ABSTRACT

A process of making a functionalized diene polymer comprising subjecting a functionalized diene monomer to a polymerization reaction to produce a side-group functionalized polymer wherein the functionalized diene monomer is selected from the group according to formulae (1) to (3)

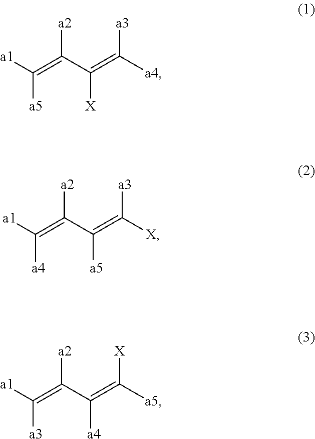

or a combination thereof, wherein a1, a2, a3, a4, a5 independently from each other represent either H or a saturated, unsaturated, linear or branched aliphatic hydrocarbon residue having from 1 to 12 carbon atoms, with the proviso that at least three of a1, a2, a3, a4 and a5 represent H, and wherein X represents a side group according to formula (4):

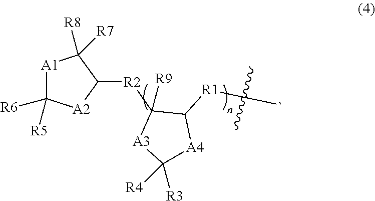

wherein in formula (4)
n is selected from 0, 1, 2, 3, 4, 5, 6, 7, 8, 9 or 10,
A1, A2, A3, A4 are identical or different and represent oxygen or —NR¹⁰R¹¹ wherein R¹⁰ and R¹¹ are identical or different and represent a C₁-C₁₂ alkyl residue or an aromatic residue with 6 to 20 carbon atoms selected from aryl, alkylaryl or arylalkyl, and wherein at least one of A1 or A2 and at least one of A3 or A4 represents oxygen,
R1 and R2 are identical or different and represent saturated or unsaturated, linear or branched divalent alkylenes containing from 1 and up to 20 carbon atoms;
R3, R4, R5, R6 are identical or different and represent H, a saturated, linear or branched aliphatic hydrocarbon with 1 to 10 carbon atoms which may contain one or more heteroatoms selected from N, S or O, or an aromatic residue which may contain one or more heteroatoms selected from N, S or O and contains from 5 and up to 20 carbon atoms;
R7, R8, R9 are identical or different and represent H, a linear or branched, saturated or unsaturated aliphatic, preferably alkyl, residue containing from 1 and up to 20 carbon atoms, and wherein the polymerization reaction comprises a homopolymerization or a copolymerization, and
wherein the functionalized polymer comprises one or more side groups X according to formula (4), wherein the process, optionally, comprises converting the side groups X into side groups Y according to formula (5),

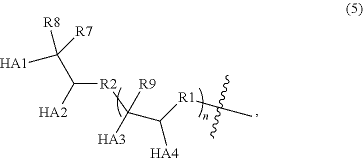

Also provided are compositions containing a polymer obtainable by the process, articles obtained with the compositions and methods of making articles.

### FIELD

The present disclosure relates to diene polymers that contain functional groups as side chains, to methods of making them and to applications of the polymers.

### BACKGROUND

Diene rubbers are elastomeric polymers containing units derived from one or more diene monomers, typically diene monomers with a conjugated carbon-carbon double bond. Diene rubbers produced with one or more butadiene, in particular 1,3-butadiene or 2-methyl-1,3-butadiene (isoprene), are commercially widely used as synthetic rubbers. Synthetic rubbers may be used, amongst other applications, as a major component of tires, with fillers typically being the other major component.

The compatibility of diene rubbers with fillers in rubber compounds can be improved by introducing polar functionalities to the polymer chains. Improved polymer-filler interactions allow for better filler dispersion and ultimately improved compound properties. In the tire industry, for example, it is known that improved polymer-filler interactions in rubber compounds can lead to lower rolling resistance and higher wet grip of tires.

Various methods for the preparation of functional diene rubbers have been developed, which largely focus on functionalizing the polymer chain ends with functional groups. Chain-end modification has the limitation that the functional groups can be introduced only at two positions of the polymer chain, at the head and at the terminal end of the polymer chain.

Alternative methods employ in-chain modifications. The in-chain functionalization of diene polymers can be generated via post-polymerization reactions or by copolymerization with a functionalized monomer. Post-polymerization approaches have the disadvantage of poor regioselectivity and often lead to undesired side reactions. Introducing functional groups through functional monomers allows for a better control over the distribution of the functional groups. However, the functional monomers should be sufficiently stable under the polymerization conditions. Examples of diene rubbers that are in-chain-functionalized with phosphine and phosphoniums are described, for example, in patent application US2020/0062878A1. However, there is a need for alternative functionalized polymers and for methods of making them.

### SUMMARY

Therefore, in one aspect there is provided a process of making a functionalized polymer comprising subjecting a functionalized diene monomer to at least one polymerization reaction to produce a functionalized polymer wherein the functionalized diene monomer is selected from the group according to formulae (1) to (3)

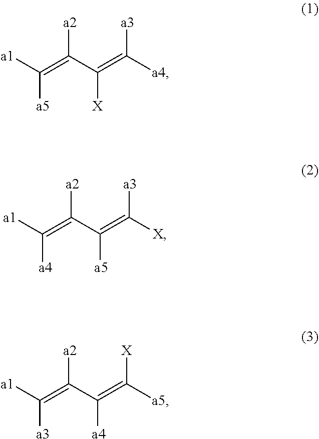

or a combination thereof, wherein a1, a2, a3, a4, a5 independently from each other represent either H or a saturated, unsaturated, linear or branched aliphatic hydrocarbon residue having from 1 to 12 carbon atoms, preferably H or —CH₃, with the proviso that at least three of a1, a2, a3, a4 and a5 represent H, and wherein X represents a side group according to formula (4):

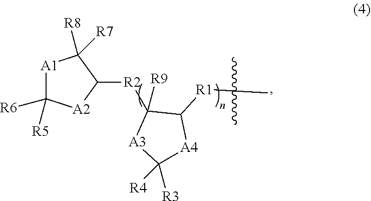

wherein in formula (4)
n is selected from 0, 1, 2, 3, 4, 5, 6, 7, 8, 9 or 10, preferably n is either 0, 1 or 2,
A1, A2, A3, A4 are identical or different and represent oxygen or —NR¹⁰R¹¹ wherein R¹⁰ and R¹¹ are identical or different and represent a C₁-C₁₂ alkyl residue or an aromatic residue with 6 to 20 carbon atoms selected from aryl, alkylaryl or arylalkyl, and wherein at least one of A1 or A2 and at least one of A3 or A4 represents oxygen,
R1 and R2 are identical or different and represent saturated or unsaturated, linear or branched divalent alkylenes containing from 1 and up to 20 carbon atoms; preferably up to 10 carbon atoms;
R3, R4, R5, R6 are identical or different and represent H, a saturated, linear or branched aliphatic hydrocarbon with 1 to 10 carbon atoms which may contain one or more heteroatoms selected from N, S or O, or an aromatic residue which may contain one or more heteroatoms selected from N, S or O and contains from 5 and up to 20 carbon atoms; preferably, at least one of R3, R4, R5 and R6 are methyl groups;
R7, R8, R9 are identical or different and represent H, a linear or branched, saturated or unsaturated aliphatic, preferably alkyl, residue containing from 1 and up to 20 carbon atoms, preferably up to 10 carbon atoms, and wherein the functionalized polymer comprises one or more groups X according to formula (4),
and wherein the process, optionally, further comprises converting, preferably by conversion comprising an acidic treatment, at least some of the groups X of the polymer to groups Y according to formula (5),

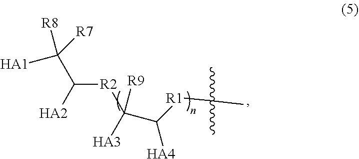

wherein in formula (5) n, R1, R2, R7, R8, R9, A1, A2, A3 and A4 have the same meaning as defined in formula (4).

In another aspect there is provided a composition comprising a polymer having units according to formula (2-1) to (2-4) and (10) to (14) or a combination thereof:

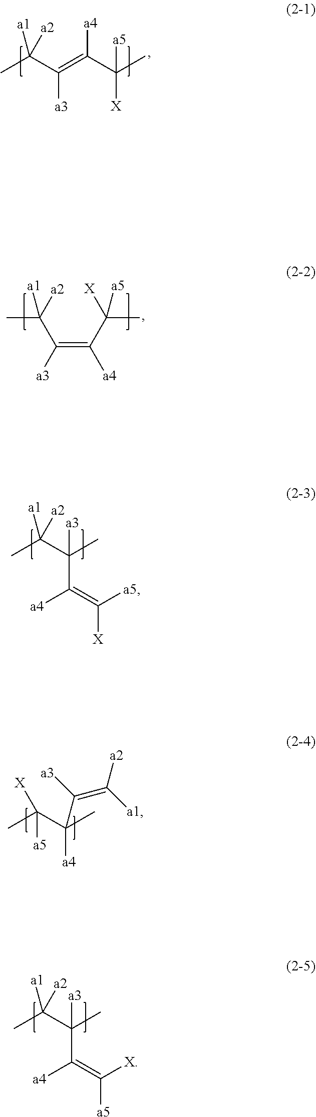

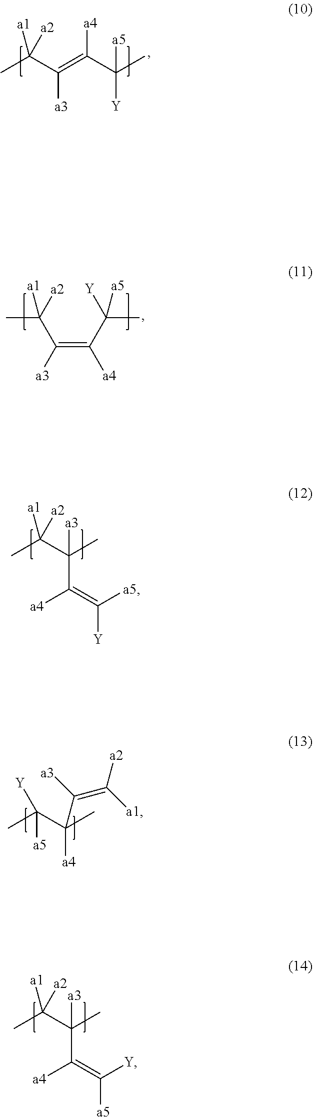

wherein a1, a2, a3, a4 and a5 have the same meaning as defined in claim 1 and wherein X represents a side group according to formula (4):

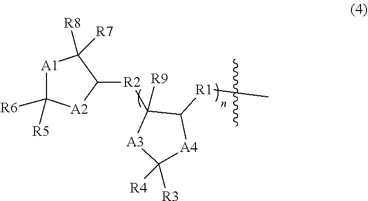

and wherein Y represents a side group according to formula (5):

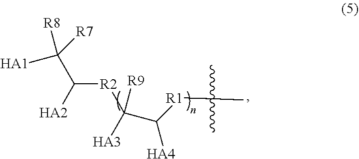

wherein in formula (4) or (5) n, A1, A2, A3, A4, R1, R2, R3, R4, R5, R6, R7, R8 and R9 have the same meaning as in claim 1.

In yet another aspect there is provided an article comprising the reaction product of a curing reaction of a composition comprising at least one curing agent and the composition comprising the polymer.

In a further aspect there is provided a method of making an article comprising subjecting a composition comprising the composition comprising the polymer and at least one curing agent to at least one curing reaction wherein the method further comprises at least one shaping step wherein the at least one shaping step can take place before, during or after the curing reaction.

### DETAILED DESCRIPTION

In the following description contrary to the term “consisting of”, the terms “comprising”, “containing”, “including”, “having” are not intended to exclude the presence of any additional component, step or procedure.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means parts per hundred parts of rubber, i.e. the weight percentage based on the total amount of rubber which is set to 100%.

Ranges identified in this disclosure include and disclose all values between the endpoints of the range and also include the end points unless stated otherwise.

The term “substituted” is used to describe hydrocarbon-containing organic compounds where at least one hydrogen atom has been replaced by a chemical entity other than a hydrogen. That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms have been replaced. For example, the term “unsubstituted methyl residue” refers to a methyl, i.e. —CH₃.

### Functionalized Monomers

In one aspect of the present disclosure there are provided functionalized diene monomers. The monomers, or a combination thereof, can be polymerized or copolymerized to provide functionalized polymers or copolymers, respectively. The monomers may be used to make homopolymers, copolymers. Preferably they are used to introduce functional groups into polymers by copolymerizing the functional monomers or polymerized entities thereof, also referred to herein as “blocks” obtained by the polymerization of the functionalized monomers and typically containing from 2 to 1000, from 2 to 300, from 2 to 100, or from 2 to 10 repeating units derived from the functionalized monomers, with one or more than one other comonomer. The functional monomers according to the present disclosure, including a combination thereof, can be used to introduce functional groups localized at the head or tail position of a polymer or randomly, or controlled, along the polymer chain. Also blocks of functional groups may be introduced by using blocks prepared from the functional monomers. Such blocks may be formed at the head position of the polymer when the monomer blocks are used together with the initiator or along the polymer chain or at the terminal position of the polymer by adding the blocks during or towards the end of the polymerization reaction, respectively, and including combinations thereof. It may be desirable to use the functionalized monomers, or blocks thereof, in small amounts compared to the amounts of the other comonomers when preparing comonomers because a small portion of the functionalized monomers or a combination may be sufficient for providing sufficient amounts of functionalized groups to the copolymer, in particular when only a head or tail or head and tail functionalization of the polymer is desired.

The functionalized diene monomers according to the present disclosure generally correspond to formula (1) to (3):

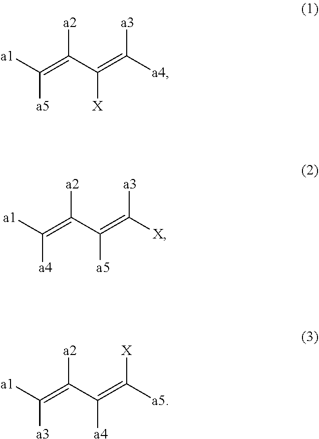

In formulae (1) to (3) a1, a2, a3, a4, a5, represent, independently from each other, either H or a saturated or unsaturated, linear or branched aliphatic hydrocarbon residue having from 1 to 12 carbon atoms, preferably methyl, with the proviso that at least three of a1, a2, a3, a4 and a5 represent H. Preferably, only one of a1, a2, a3, a4 and a5 represents methyl (—CH₃) and all others represent H, or all of a1, a2, a3, a4 and a5 represent H. X represents a group according to formula (4):

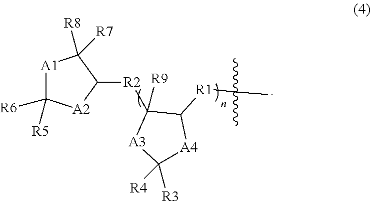

In formula (4) n is selected from 0, 1, 2, 3, 4, 5, 6, 7, 8, 9 or 10. Preferably n is either 0, 1 or 2.

A1, A2, A3, A4 are identical or different and represent oxygen or —NR¹⁰R¹¹ wherein R¹⁰ or R¹¹ are identical or different and represent a C₁-C₁₂ alkyl, or an aromatic residue with 6 to 20 carbon atoms selected from aryl, alkylaryl or arylalkyl, and wherein at least one of A1 or A2 and at least one of A3 or A4 represents oxygen. Preferably A1, A2, A3 and A4 all represent oxygen.

In formula (4) R1 and R2 are identical or different and represent saturated or unsaturated, linear or branched divalent alkylenes with 1 and up to 20 carbon atoms. Preferably, R1 and R2 represent, independently from each other, a saturated or unsaturated, linear or branched divalent alkylene having 2, 3, 4, 5, 6, 7, 8, 9 or 10 carbon atoms.

R3, R4, R5, R6 are identical or different and represent H, a saturated, linear or branched aliphatic hydrocarbon with 1 to 10 carbon atoms which may contain one or more heteroatoms (N, S, or O) or an aromatic residue which may contain one or more heteroatoms (N, S, or O) and contains from 5 and up to 10 carbon atoms. Preferably, at least one of R3, R4, R5 and R6 are methyl groups.

R7, R8, R9 are identical or different and represent H, a linear or branched, saturated or unsaturated alkyl residue containing from 1 and up to 20 carbon atoms, preferably from 1 to 10 carbon atoms. In one embodiment R7 and R8 are methyl or ethyl and preferably both are methyl.

Preferred embodiments of the functionalized diene monomers according to the present disclosure are represented by formulae (1′)-(3′):

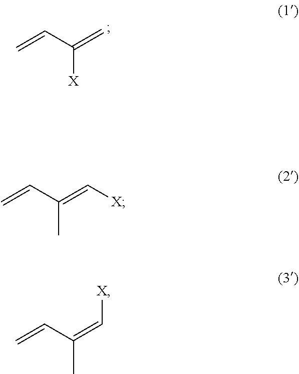

including a combination thereof, wherein X has the same meaning as described above.

In a preferred embodiment of the present disclosure the group X is represented by formula (4′):

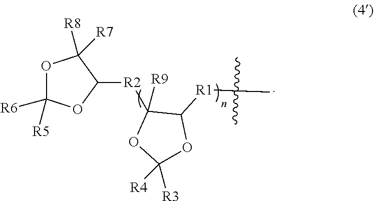

In formula (4′) n, R1, R2, R5, R6, R7, R8 and R9 have the meaning as above.

In one embodiment of the present disclosure the functionalized diene monomer is selected from formulae (6) to (9) or a combination thereof:

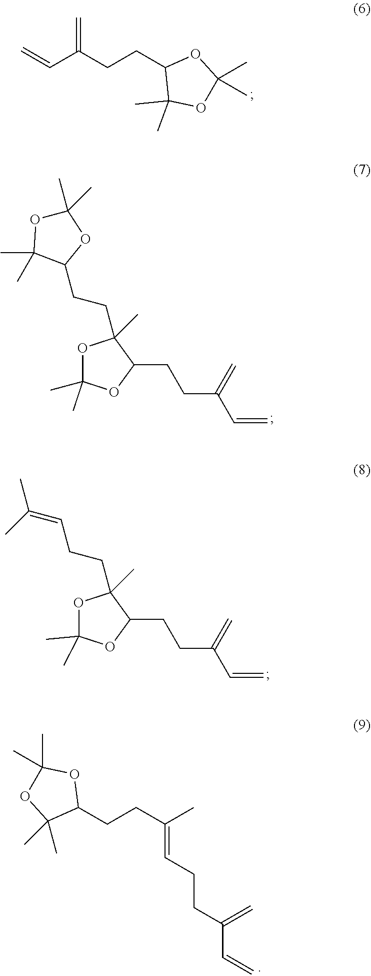

The functionalized diene monomers of the present disclosure may be obtained, for example, by epoxidizing the carbon-carbon double bond of a butadiene that is substituted by a residue having at least one additional carbon-carbon double bond. Such a substituent is also referred to herein as “side chain”. Preferably, the epoxidation of the carbon-carbon-double bond is selective and the epoxidation does not take place at the conjugated diene unit or only to a lesser extent. Such selective epoxidation may be carried out, for example, by using meta-chloroperoxobenzoic acid but other epoxidation agents as known in the art may be used also, including but not limited to tert-butyl hydroperoxide, hydrogen peroxide, 1-phenylethylhydroperoxide or cumene hydroperoxide. The resulting epoxy-functionalized side group of the monomer may subsequently be converted to group X. This conversion may include, for example, the reaction of the epoxy-functionalized side chain with a ketone, preferably a dialkyl ketone, including but not limited to acetone, ethyl methyl ketone, diethyl ketone, preferably acetone, to form dioxolane-functionalized side chains (in which case A1 and A2, or A3 and A4, or A1 to A4 in formula (4) represent oxygen). This reaction is known and may be catalyzed by a Lewis acid catalyst. Suitable Lewis acid catalysts include but are not limited to SnCl₂. BF₃OEt₂, SnCl₄, anhydrous CuSO₄, TiCl₄, RuCl₃, bismuth(III)salts, 2,4,4,6-tetrabromo-2,5-cyclohexadienone, tin(IV)tetraphenylporphyrin perchlorate, CH₃ReO₃, and various zeolites. Instead of dialkyl ketones other reagents as known to the person skilled in the art may be used. Instead of dioxolane-functionalized side groups other side groups may be created, for example side groups functionalized by N,O-acetals. For example, the epoxy-functionalized side group of the monomer can be reacted with an amine to form an amino alcohol group. In a subsequent step, the amino alcohol group can be reacted with a ketone, preferably a dialkyl ketone, to form an N,O-acetal group. In this case one of A1 or A2 and/or one of A3 and A4 in formula (4) represents N and the other one represents 0.

In a preferred embodiment of the present disclosure, the monomers are obtained from sustainable resources like plants, followed by epoxidation and subsequent conversion of the epoxy groups as described above. Examples of suitable materials for making the monomers include but are not limited to myrcene, ocimenes and/or farnesene.

Polymers with Groups X

The functionalized diene monomers according to the present disclosure can be polymerized or copolymerized and the resulting polymer or copolymer has one or more side groups X.

Therefore, in one aspect of the present disclosure, a polymer is provided that contains units, preferably repeating units, derived from one or more functionalized monomers according to the present disclosure. In one embodiment of the present disclosure a polymer is provided comprising units, preferably repeating units, according to formulae (2-1) to (2-5):

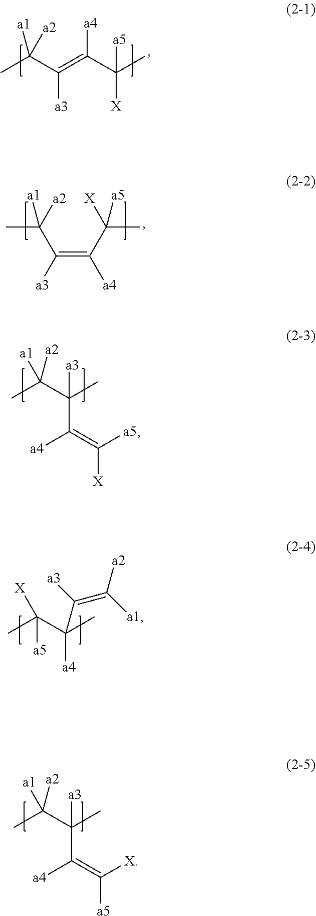

In the structures according to formulae (2-1) to (2-5) a1, a2, a3, a4, a5 and X have the same meaning as described above.

The polymer of the present disclosure may be a homopolymer or a copolymer. In one embodiment of the present disclosure the polymer is a copolymer and is obtained by a polymerization reaction comprising copolymerizing one or more functionalized monomers according to the present disclosure thereof with at least one additional comonomer or blocks thereof, i.e. reactive units comprising repeating units derived from such comonomers. Also blocks of functionalized monomers may be used for the copolymerization with comonomers or blocks of comonomers.

In one embodiment of the present disclosure, the polymer is a copolymer. Suitable comonomers include, but are not limited to, dienes, preferably conjugated dienes (hereinafter referred to as conjugated diene comonomer(s)) and vinyl aromatic monomers.

Suitable conjugated diene comonomers include but are not limited to 1,3-butadiene, isoprene, 1,3-pentadiene, 2,3-dimethylbutadiene, 1-phenyl-1,3-butadiene, 1,3-hexadiene and combinations thereof. 1,3-butadiene and/or isoprene are particularly preferred.

Examples of suitable vinyl aromatic comonomers include, but are not limited to, styrene, ortho-methyl styrene, meta-methyl styrene, para-methyl styrene, para-tertbutyl styrene, vinyl naphthalene, divinyl benzene, trivinyl benzene, divinyl naphthalene and combinations thereof. Styrene is particularly preferred.

In one embodiment of the present disclosure the polymer is a copolymer of one or more functionalized monomers according to the present disclosure, at least one diene comonomer, preferably a conjugated diene monomer, and at least one vinyl aromatic comonomer.

In one embodiment the copolymer contains units derived from butadiene, or from butadiene and styrene. Such polymers are particularly suitable for the manufacture of tires or tire components.

The copolymer may only contain only small amounts derived from the functionalized monomers according to the present disclosure because the monomers provide a comparatively high number of functional groups, in particular when blocks of repeating units of functionalized monomers are used. Preferably the units derived from the functionalized monomers and more preferably such blocks of functionalized monomers, may be positioned at the head (alpha-position) or at the tail (omega-position) of the copolymer, or both at the head and at the tail position (alpha-omega position) of the copolymer.

In one embodiment of the present disclosure there is provided a copolymer having from 0.01% by weight to 10% by weight (based on the total weight of the polymer) of units derived from the functionalized monomers according to the present disclosure, for example from 0.01-5% by weight or from 0.05 to 2% by weight or from 0.1 to 1% by weight.

In one embodiment of the present disclosure the copolymer has at least one unit derived from a functionalized monomer according to the present disclosure per polymer chain, preferably at least 2, from 2 to 50, from 1 to 15, or from 1 to 5. To generate one unit of functionalized polymer per chain, functionalized monomer and initiator are added in equimolar amounts. Likewise 2 units per polymer chain can be generated by using a molar ratio of functionalized monomer to initiator of 2:1.

In one embodiment of the present disclosure there is provided a copolymer comprising from 0.2% to 10% by weight of units derived from the functionalized diene monomers of the present disclosure and from 90% to 99.8% by weight of units derived from at least one diene comonomer. In one embodiment of the present disclosure, the polymer may contain from 55% to 92% by weight of units derived from one or more diene comonomer and from 7.8% to 44.8% by weight of units derived from vinyl aromatic comonomers and from 0.2% to 10% by weight of units derived from the functionalized diene monomers of the present disclosure.

The copolymer may further comprise from 0.1 to 10% by weight of one or more other comonomers.

### Polymerization Reactions

The functionalized diene monomers of the present disclosure can be used to produce a functionalized polymer by a process comprising subjecting one or more functionalized diene monomer to at least one polymerization reaction to produce the functionalized polymer. The functionalized polymer may be a homopolymer or a copolymer. The polymer may be a statistical copolymer, also called random copolymer, a block-copolymer, a gradient polymer or a combination thereof. The polymer may have a linear or branched architecture or other architecture as known by the person skilled in the art and the polymer can be prepared by methods known in the art.

Preferably the polymers are obtained by a polymerization reaction comprising anionic polymerization, radical polymerization or a catalytic polymerization using one or more coordination catalysts. Coordination catalysts in this context include Ziegler-Natta catalysts or monometallic catalyst systems. Preferred coordination catalysts are those based on Ni, Co, Ti, Zr, Nd, V, Cr, Mo, W or Fe.

Preferably the polymerization reaction comprises or consists of an anionic solution polymerization. Initiators for anionic solution polymerizations include organometals, preferably based on alkali or alkaline earth metals. Examples include but are not limited to methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, phenyllithium, 4-butylphenyllithium, 1-naphthyllithium, p-toluyllithium and allyllithium compounds, derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl]lithium, lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. The allyllithium compounds and the lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium, sec-butyllithium or a combination thereof are used.

Randomizers and control agents as known in the art can be used in the polymerization for controlling the structure of the polymer, in particular for avoiding aggregations or for increasing random structures. Such agents include, for example, diethyl ether, di-n-propylether, diisopropyl ether, di-n-butylether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N,N′,N′-tetramethyl-ethylenediamine, N-methylmorpholine, N-ethylmorpholine, 1,2-dipiperi-dinoethane, 1,2-dipyrrolidinoethane, 1,2-dimorpholinoethane, potassium and sodium salts of alcohols, phenols, carboxylic acids, sulphonic acids and combinations thereof.

In one embodiment of the present disclosure the polymer is a random polymer and, preferably, at least one randomizer is used in the polymerization reaction.

In one embodiment of the present disclosure the polymer is a block-copolymer, preferably containing one or more blocks made of repeating units derived from the functionalized diene monomers of the present disclosure. Preferably such a block is present at the alpha, or omega or alpha and omega position of the polymer. For generating block-copolymers the polymerization is preferably carried out with one type of monomer or comonomer only and subsequently, depending on the size of the blocks to be created, the other (co)monomer(s) are added. The sequence of monomer additions can be adapted depending on which blocks and how many of them are desired to be created. To create a block of functionalized diene monomers at the alpha position, the functionalized and initiators are added together to the polymerization before the other comonomers are added. Blocks of functionalized monomers within the chain or at the terminal position of the polymer can be generated or by stopping or interrupting the comonomer feed and feeding only or predominantly the functionalized monomers to the polymerization reaction.

In one embodiment of the present disclosure the polymerization is carried out in the presence of at least one solvent and preferably in solution. Preferred solvents for solution polymerizations include inert aprotic solvents, for example aliphatic hydrocarbons. Specific examples include, but are not limited to, butanes, pentanes, hexanes, heptanes, octanes, decanes and cyclopentane, methylcyclopentane, cyclohexane, methylcyclohexane, ethylcyclohexane, 1,4-dimethylcyclohexane and combinations thereof and including isomers thereof. Further examples include alkenes such as 1-butene or aromatic hydrocarbons such as benzene, toluene, ethylbenzene, xylene, diethylbenzene or propylbenzene and combinations thereof. These solvents can be used individually or as mixtures. Preferred solvents include cyclohexane, methylcyclopentane and n-hexane. The solvents may also be mixed with polar solvents if appropriate.

The polymerization can be carried out by first introducing the (co)monomers and solvent and then starting the polymerization by adding initiator or catalyst. The polymerization may also be carried out in a feed process where the polymerization reactor is filled by adding monomers and solvents. The initiator or catalyst are introduced or added with the monomers and solvent. Variations may be used, such as introducing the solvent in the reactor, adding initiator or catalyst followed by adding the monomers. The polymerization can be carried out in a continuous mode or batchwise. Further monomer and solvent may be added during or at the end of the polymerization.

The polymerization may usually be carried out within a period of 10 minutes to 8 hours, preferably from 20 minutes to 4 hours. The polymerization can be carried out at normal pressure or at elevated pressure (for example, from 1 to 10 bar) or at reduced pressure.

Typical reaction temperatures include room temperature but depending on the nature and amounts of comonomers the reaction temperature may be above or below room temperature.

Coupling reagents typical for anionic diene polymerizations can be used if desired. Examples of such coupling reagents include silicon tetrachloride, methyltrichlorosilane, dimethyldichlorosilane, tin tetrachloride, dibutyltin dichloride, tetraalkoxysilanes, ethylene glycol diglycidyl ether, 1,2,4-tris(chloromethyl)benzene. Such coupling reagents may be added during the polymerization or at the end of the polymerization or after the polymerization has completed.

Antioxidants as known in the art, such as sterically hindered phenols, aromatic amines, phosphites, thioethers, may be added to the reaction mixture. Preferably they are added before or during the working up of the polymers of the present disclosure.

The reaction may be terminated, for example, by quenching. Quenching agents known in the art may be used. Typical quenching agents for terminating the polymerization include alcohols, for example octanol.

The resulting polymers may be worked up and isolated and shaped, if desired, into granules, pellets or bales as known in the art.

Extender oils used for diene rubbers such as TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils can be added to the reaction mixture prior or during work up. Fillers, such as carbon-based fillers, for example carbon blacks, silica, other rubbers and rubber additives can be added to the reaction mixture prior or during work up—or also after work up to the isolated polymer as will be described in greater detail with respect to polymer compounds.

The solvent can be removed from the reaction mixture by conventional methods including distillation, stripping with steam or by applying a vacuum or reduced pressure, if necessary, at elevated temperatures. Typically, the solvent is recycled. The polymer crumbs can be further dried on mills or processed on mills, for example into sheets, or compressed for example into bales.

Functionalized polymers may be produced that have a number averaged molecular weight (Mn) of at least 1,000 g/mole or at least 10,000 g/mole. For example, the polymers may have a number-averaged molecular weight of from 10,000 to 2,000,000 g/mol, or from 100,000 to 1,000,000 g/mol. The Mn can be determined by SEC as described in the experimental section.

Preferably, the functionalized polymers according to the present disclosure are rubbers. Rubber typically have a glass transition temperature (Tg) of less than 20° C. In one embodiment of the present disclosure functionalized polymers may be produced that have a Tg of from about −110° C. to about +20° C., preferably of from about −110° C. to about 0° C., or from about −12° C. to about −65° C.

In one embodiment of the present disclosure functionalized polymers may be produced that have a Mooney viscosity [ML 1+4 (100° C.)] of from about 10 to about 200, preferably from about 30 to about 150 Mooney units or from 35 to 75 Mooney units. The Mooney viscosity of the polymers can be measured according to DIN ISO 289-1 (2018) at the measuring conditions ML(1+4) at 100° C.

In one embodiment of the present disclosure functionalized polymers may be produced that have a molecular weight distribution from about 1.03 to 25, for example from 1.03 to about 3.5.

It is contemplated that polymers with additional functional end groups other than those represented by side chain X can be produced, for example by functionalization of the head or terminal ends of the polymer chains or by using different functionalized monomers to produce side-chain-functionalized polymers. Functionalization methods as known in the art may be used including, for example, those described in US2013/0281605; US2013/0338300; US2013/0280458, US2016/0075809; US2016/0083495; WO2021/009154; WO2021/009156; WO2009077839 and references cited therein.

### Conversion of Groups X of the (X-Functionalized) Polymer to Groups Y to Provide a Y-Functionalized Polymer

In one embodiment of the present disclosure the polymer obtained by the polymerization reaction described above may be treated to convert at least some of the groups X of the polymer to groups Y. This conversion step can be carried out with the isolated polymer or with a composition containing the polymer, for example in a rubber compound or during the process of making a rubber compound, or with a solution containing the polymer, for example a reaction mixture from the polymerization reaction.

Preferably, the conversion is carried out with the polymer obtained after the polymerization reaction, optionally after some purification steps to remove residues from the polymerization, such as unreacted monomers, residues from catalysts and quenching agents, or exchanging or changing solvents. The conversion may also be carried out directly in the reaction mixture obtained after the polymerization. The resulting polymer contains groups Y, wherein Y represents a group according to formula (5):

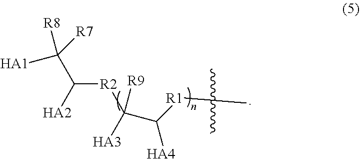

In formula (5) n, R1, R2, R7, R8 and R9 have the same meaning as described above for group X. Like the group X also the group Y may be a pending group, i.e. a side group of the polymer chain.

Therefore, in one aspect of the present disclosure there is provided a polymer containing units, preferably repeating units, according to formulae (10) to (14):

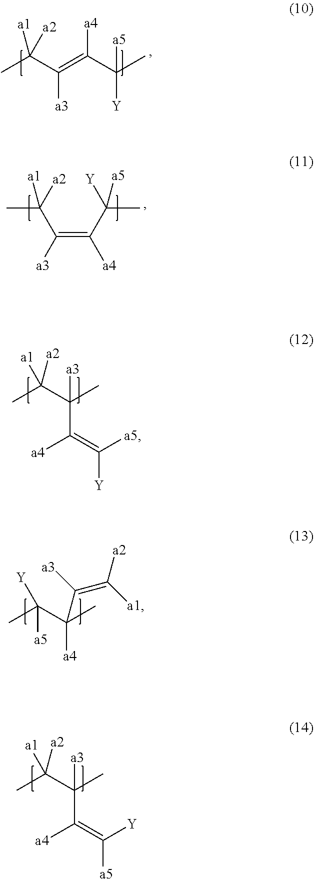

or a combination thereof, wherein a1, a2, a3, a4, a5 and Y have the same meaning as defined above.

In a preferred embodiment of the present disclosure A1 to A4 all represent oxygen and Y represents a group according to formula (5):

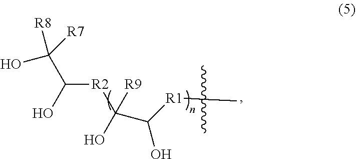

wherein n, R1, R2, R7, R8 and R9 have the same meaning as described above. In this embodiment a hydroxy-functionalized polymer is provided, i.e., the polymer contains hydroxy-groups. In another embodiment of the present disclosure the polymer is hydroxy-functionalized and Y is represented by formulae (15)-(19):

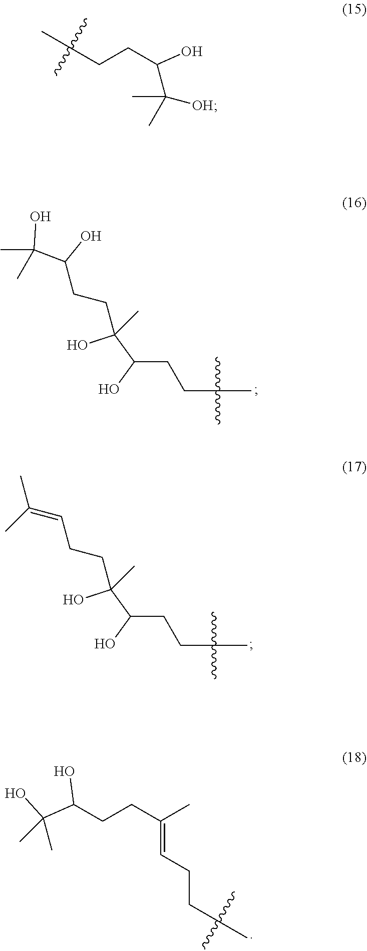

The polymer with groups Y has the same architecture and composition as described above for the polymer with groups X—except for the presence of groups X and Y respectively.

In one embodiment of the present disclosure the Y-functionalized polymers may be produced that have a number averaged molecular weight (Mn) of at least 1,000 g/mole or at least 10,000 g/mole. For example, the polymers may have a number-averaged molecular weight of from 10,000 to 2,000,000 g/mol, or from 100,000 to 1,000,000 g/mol. The Mn can be determined by SEC as described in the experimental section.

In one embodiment of the present disclosure the Y-functionalized polymers are rubbers. Rubber typically have a glass transition temperature (Tg) of less than 20° C. In one embodiment of the present disclosure Y-functionalized polymers may be produced that have a Tg of from about −110° C. to about +20° C., preferably of from about −110° C. to about 0° C., or from about −12° C. to about −65° C.

In one embodiment of the present disclosure Y-functionalized polymers may be produced that have a Mooney viscosity [ML 1+4 (100° C.)] of from about 10 to about 200, preferably from about 30 to about 150 Mooney units or from 35 to 75 Mooney units. The Mooney viscosity of the polymers can be measured according to DIN ISO 289-1 (2018) at the measuring conditions ML(1+4) at 100° C.

In one embodiment of the present disclosure Y-functionalized polymers may be produced that have a molecular weight distribution from about 1.03 to 25, for example from 1.03 to about 3.5.

The conversion of the groups X of the polymer to groups Y to provide the Y-functionalized polymer according to the present disclosure is preferably carried out by subjecting the polymer to an appropriate treatment. Such treatment may include an acidic treatment, for example a treatment with one or more acids or acidic substances including acidic resins and ion-exchangers. The treatment can be carried out as known by the person skilled in the art and as appropriate, for example at ambient conditions or at reduced or elevated temperatures and pressures. The resulting polymer can be worked up as known in the art and as described above. Extender oils used for diene rubbers such as TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils can be added to the reaction mixture prior or during work up. Fillers, such as carbon-based fillers, for example carbon blacks, silica, other rubbers and rubber additives can be added to the reaction mixture prior or during work up—or also after work up to the isolated polymer as will be described in greater detail with respect to polymer compounds. Solvent can be removed from the reaction mixture by conventional methods including distillation, stripping with steam or by applying a vacuum or reduced pressure, if necessary, at elevated temperatures. Typically, the solvent is recycled. The polymer crumbs can be further dried on mills or processed on mills, for example into sheets, or compressed for example into bales.

In one embodiment of the present disclosure the conversion to group Y is carried out when preparing a rubber compound or is carried out in the rubber compound, or before or during subjection of the rubber compound to curing.

### Compositions

In one embodiment of the present disclosure there is provided a composition comprising one or more of the X-functionalized polymers, the Y-functionalized polymers or a combination thereof. The composition may comprise from 1% to 100% by weight, or from 10% to at least 90% by weight, of one or more X- or Y-functionalized polymers according to the present disclosure wherein the % by weight are based on the total weight of the composition and wherein the total weight of the composition is 100%. In case the X- or Y-functionalized polymers are oil-extended the amounts indicated for the polymer are the combined amounts of polymer and extender-oil. The compositions can be used to make rubber compounds. Rubber compounds may be made by a process comprising mixing the functionalized polymers according to the present disclosure with one or more filler and thus comprise at least the functionalized polymer according to the present disclosure and at least a filler. The rubber compound may also include at least one cross-linking agent for cross-linking at least the functionalized polymer. Such compounds can be made by a process comprising mixing the functionalized polymer with one or more filler and one or more cross-linking agent for cross-linking the functionalized polymer. The rubber compounds may contain active or inactive fillers or both and conventional fillers can be used. Conventional fillers include silicas, silicates and, preferably, one or more than one carbon-based fillers, for example carbon blacks.

Examples of suitable silicas include but are not limited to highly disperse silicas, produced for example by precipitation of solutions of silicates or flame hydrolysis of silicon halides with specific surfaces of 5-1000, preferably 20-400 m²/g (BET surface) and primary particle sizes of 10-400 nm. Silicas may also be present as mixed oxides with other metal oxides such as Al, Mg, Ca, Ba, Zn, Zr, Ti oxides; synthetic silicates such as aluminum silicate, alkaline earth silicate such as magnesium silicate or calcium silicate, with BET surfaces of 20-400 m²/g and primary particle diameters of 10-400 nm; natural silicates such as kaolin, montmorillonite and other naturally occurring silicas.

Examples of suitable fillers that are not silicas and are not carbon-based include but are not limited to glass fibers and glass fiber products (mats, strands) or microspheres (which may also contain silicas or silicates); metal oxides such as zinc oxide, calcium oxide, magnesium oxide, aluminum oxide; metal carbonates, such as magnesium carbonate, calcium carbonate, zinc carbonate; metal hydroxides, such as aluminum hydroxide, magnesium hydroxide; metal sulfates, such as calcium sulfate, barium sulfate; rubber gels, in particular those based on BR, E-SBR and/or polychloroprene, preferably with particle sizes from 5 to 1000 nm.

Examples of suitable carbon-based fillers include but are not limited to carbon blacks produced by the flame soot, channel, furnace, gas soot, thermal, acetylene soot or arc process. The carbon-based fillers may have BET surfaces of 9-200 m2/g. Examples of specific carbon blacks include but are not limited to SAF-, ISAF-LS-, ISAF-HM-, ISAF-LM-, ISAF-HS-, CF-, SCF-, HAF-LS-, HAF-, HAF-HS-, FF-HS-, SPF-, XCF-, FEF-LS-, FEF-, FEF-HS-, GPF-HS-, GPF-, APF-, SRF-LS-, SRF-LM-, SRF-HS-, SRF-HM- and MT- soot or according to ASTM N110-, N219-, N220-, N231-, N234-, N242-, N294-, N326-, N327-, N330-, N332-, N339-, N347-, N351-, N356, N358, N375, N472, N539, N550, N568, N650, N660, N754, N762, N765, N774, N787 and N990 carbon blacks.

Preferably, the rubber compounds of the present disclosure contain one or more carbon blacks as fillers.

The fillers can be used alone or in a mixture. In a particularly preferred form, the rubber compositions contain a mixture of silica fillers, such as highly dispersed silicas, and carbon black.

The fillers may be used in quantities ranging from 10 to 500, preferably from 20 to 200 parts by weight based on 100 parts by weight of rubber.

The rubber compounds may further contain one or more additional rubbers other than the functionalized rubbers according to the present disclosure and one or more than one rubber additive. Additional rubbers include, for example, natural rubber and synthetic rubber. If present, they may be used in amounts in the range from 0.5 to 95% by weight, preferably in the range from 10 to 80% by weight, based on the total amount of rubber in the composition. Examples of suitable synthetic rubbers include BR (polybutadiene), acrylic acid alkyl ester copolymers, IR (polyisoprene), E-SBR (styrene-butadiene copolymers produced by emulsion polymerization), S-SBR (styrene-butadiene copolymers produced by solution polymerization), IIR (isobutylene-isoprene copolymers), NBR (butadiene-acrylonitrile copolymers), HNBR (partially or completely hydrogenated NBR rubber), EPDM (ethylene-propylene-diene terpolymers) and mixtures thereof. Natural rubber, E-SBR and S-SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include crosslinking agents such as sulfur or sulfur-supplying compounds, reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators.

The total amount of rubber additives may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

### Applications

The compositions according to the present disclosure can be used for producing rubber vulcanizates, in particular tires or components of tires like tire treads. The rubber compositions provided herein are also suitable for the manufacture of articles, for example for the manufacture of cable sheaths, hoses, drive belts, conveyor belts, roll linings, shoe soles, sealing rings and damping elements.

Therefore, in another aspect of the present disclosure there is provided an article, in particular a tire or tire component, comprising the reaction product of a curing reaction comprising a composition comprising at least one functionalized polymer according to the present disclosure and at least one curing agent capable of curing the functionalized polymer. For example, the article may contain a vulcanized rubber composition obtained by vulcanizing the rubber compositions provided according to the present disclosure. The process for making articles may include at least one shaping step. The shaping step can be carried out before, during or after the curing reaction (vulcanization reaction).

The following examples are provided to further illustrate the present disclosure without any intention to limit the disclosure to the embodiments set forth in these examples.

### EXAMPLES

### Reagents:

Chemicals and solvents were purchased from commercial suppliers (Acros, Sigma-Aldrich, Fisher Scientific, Alfa Aesar, TCI). Deuterated solvents were obtained from Deutero GmbH. Isopropyl alcohol and methanol were used as received without further purification. Cyclohexane was purified by stirring over diphenylhexyllithium (adduct of sec-butyllithium and 1,1-diphenylethylene), vacuum-transferred and degassed by three freeze-pump-thaw cycles prior to use. All monomers for the polymerization were degassed by three freeze-pump-thaw cycles prior to use.

### NMR Spectrometry:

NMR spectra were recorded on a Bruker Avance II 400 spectrometer equipped with a 5 mm BBFO-SmartProbe with z gradient and ATM and a SampleXPress 60 sample changer. All spectra are referenced internally to residual proton signals of the deuterated solvent.

### Size Exclusion Chromatography:

Size exclusion chromatography (SEC) measurements for determining the number-averaged molecular weight (Mn) and the weight-averaged molecular weight (Mw) were performed using an Agilent 1100 Series, equipped with a SDV column set from PSS (SDV 103, SDV 105, SDV 106). Tetrahydrofuran (THF) was used as the mobile phase (flow rate 1 mL/min) and as the solvent. Standards were used for calibration as indicated in the examples. The measurements were carried out at 30° C. with an RI and UV (275 nm) detector. For analysis, the PSS WinGPC® UniChrom (V 8.31, Build 8417) software provided by PSS Polymer Standards Service GmbH was used.

### Glass Transition Temperatures:

The glass transition temperatures (Tg) were determined by differential scanning calorimetry (DSC) recorded on a Perkin Elmer 8500 differential scanning calorimeter. A temperature range from −90° C. to 130° C. was used. For the first cycle a heating rate of 10° C. min⁻¹ and a cooling rate of 10° C. min⁻¹ was employed. A second heating cycle (10° C./min) was used to evaluate the thermal properties of the (co)polymers.

The vinyl and styrene content of polymers can be determined by FTIR spectroscopy on rubber films.

### Example 1 (Monomer Synthesis)

Myrcenedioxolane (MyrDOL) was prepared from myrcene as shown in scheme 1 below.

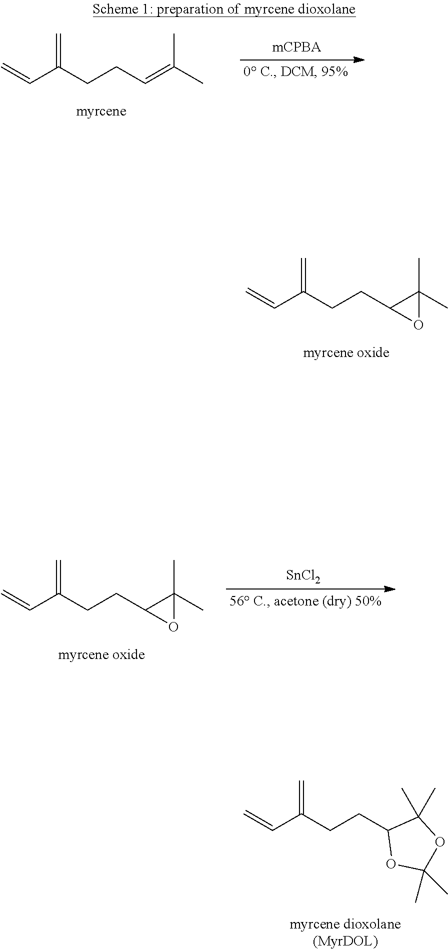

Meta-chloroperoxybenzoic acid (32 g, 0.15 mol) was added in small portions to an ice-cooled solution of myrcene (20 g, 0.14 mol) in 200 ml CH₂Cl₂. After 5 minutes 2 M aq. NaOH solution was added, and the reaction mixture was extracted with CH₂Cl₂ (3 times 300 ml). The combined organic phases were washed with water and then brine and were subsequently dried over MgSO₄. After removal of the solvent, myrcene oxide was separated by distillation (colorless oil, yield of 95%). The myrcene oxide was converted into myrcene dioxolane by placing anhydrous tin(II)chloride (2.8 g) in a two-necked 500 ml flask equipped with a magnetic stir bar and reflux condenser. This reaction unit was subsequently evacuated and filled with argon which was repeated three times. Dry acetone (400 ml) was added through a septum and the resulting mixture was stirred. Myrcene was added drop-wise and the reaction mixture was heated to reflux. After completion of the reaction the acetone was removed by rotary evaporation and the residue was taken up in CH₂Cl₂ (200 ml). 10% NaOH solution (100 ml) and water (50) were added subsequently. The resulting aqueous layer was extracted with 50 ml of CH₂CL₂. The combined organic layers were dried over Na₂SO₄ after which the solvent was removed by rotary evaporation. Myrcene dioxolane was obtained by vacuum distillation (yield 50%).

### Examples 2 to 11 (Polymerizations)

The polymerizations were carried out in cyclohexane at room temperature in an argon-filled glovebox (MBraun UNILAB, <0.1 ppm of O₂ and <0.1 ppm of H₂O) in 40 mL glass vials, equipped with a magnetic stir bar, screw caps and septa. Dry and degassed cyclohexane was distilled into a Schlenk flask equipped with a PTFE stopper. The myrcene dioxolane monomer was dried 24 h over CaH₂, and then additionally 24 h over trioctylaluminum, degassed and finally distilled into another Schlenk flask with PTFE stopper. Myrcene, isoprene and styrene monomers were dried over CaH₂ for 24 h, degassed and then distilled into another Schlenk flash with PTFE stopper. Inside the glove box the monomer(s) and cyclohexane were added into a glass vessel with septum. For the synthesis of the homopolymers and copolymers the monomer/solvent (10 wt %) mixture was initiated with 0.1 mL sec-butyllithium (1.3 M in cyclohexane/hexane 92/8) via 1 mL syringe. The solution was stirred for 24 h to ensure full monomer conversion. The polymerization was terminated by adding 0.5 mL of methanol (degassed with argon for 1 h prior to use) by a syringe. The polymers were precipitated in 30 mL of a cold methanol/isopropanol mixture and dried under reduced pressure. For making random copolymers a mixture of monomer and comonomers was provided and the polymerization reaction was initiated. For making block-copolymers the monomers were first polymerized. Then comonomers were added and the polymerization was continued.

### Example 2 and 3: Homopolymers

The monomer of example 1 was polymerized according to the general polymerization procedure to produce a homopolymer with dioxolane side groups. The results are summarized in table 1. The ratio of mass of monomer (M) in grams to molar amount of initiator in mole (m(M)/n(I)) was 3.000 g/mol in example 2 and 30.000 g/mol in example 3.

TABLE 1
Results of homopolymerizations

| Example No | Mn/kgmol⁻¹ | Mw/Mn | Tg/° C. |
|---|---|---|---|
| 2^{a} | 3.3 | 1.08 | 9 |
| 3^{b} | 31.4 | 1.13 | 11 |

^{a}= SEC calibrated with polyisoprene;
^{b}= SEC calibrated with polymethacrylate.

### Examples 4 to 7: Copolymers

Monomers prepared according to example 1 were copolymerized with different comonomers according to the general copolymerization procedure described above to produce in-chain functionalized polymers with dioxolane side chains. The ratio of m(M)/n(I) was 6.000 g/mol. Equimolar amounts of monomer of example 1 and the respective comonomer were used.

TABLE 2
Functionalized copolymers

| Example No | Comonomer | Mn/kgmol⁻¹ | Mw/Mn | Tg/° C. |
|---|---|---|---|---|
| 4^{a} | styrene | 10.0 | 1.10 | n.d. |
| 5^{b} | myrcene | 6.2 | 1.10 | −33° C. |
| 6^{b} | isoprene | 7.1 | 1.06 | n.d. |
| 7*^{b} | isoprene | 9.6 | 1.08 | n.d. |

*= DTHFP was added as randomizer;
^{a}= SEC calibrated with polystyrene,
^{b}= SEC calibrated with polyisoprene.

### Examples 8 to 11: Block-Copolymers

Various block-copolymers were prepared according to the general polymerization procedure. The results are shown in table 3. SEC was calibrated with polyisoprene, eluant was THF.

TABLE 3
Block-copolymers

| | Block A | | X_{target}(block | | |
|---|---|---|---|---|---|
| Example | (initiator) | Block B | B)/mol % | Mₙ/kgmol⁻¹ | Mw/Mn |
| 8 | isoprene | myrDOL | 10 | 21.4 | 1.12 |
| 9 | myrcene | myrDOL | 10 | 11.0 | 1.12 |
| 10 | styrene | myrDOL | 10 | 11.9 | 1.06 |
| 11 | myrDOL | myrcene | 50 | 7.6 | 1.09 |

myrDOL = dioxolane-functionalized myrcene = monomer of example 1

### Examples 12 and 13: Generation of Y-Functionalization

The polymers obtained in the polymerization reactions contained dioxolane side groups. For obtaining the hydroxy-functionalized polymers the dioxolane-functionalized polymers were treated with an acidic ion exchange resin as shown in Scheme 2 (representing the conversion of a dioxalane-functionalized myrcene homopolymer into the corresponding hydroxy-functionalized myrcene homopolymer). 500 mg of polymer were dissolved in 30 mL tetrahydrofurane (THF) and 500 mg of ion-exchange resin (a sulfonated styrene divinylbenzene (gel), DOWEX 50 W ×8 hydrogen form, strongly acidic, 200-400 mesh size, purchased from Sigma-Aldrich; recovered with diluted sulfuric acid for 30 minutes, when exhausted) were added. The resulting mixture was refluxed for 24 h. The turbid solution was centrifugated and the THF solution containing the deprotected (hydroxy-functionalized) polymer was separated. THF was removed by rotatory evaporation.

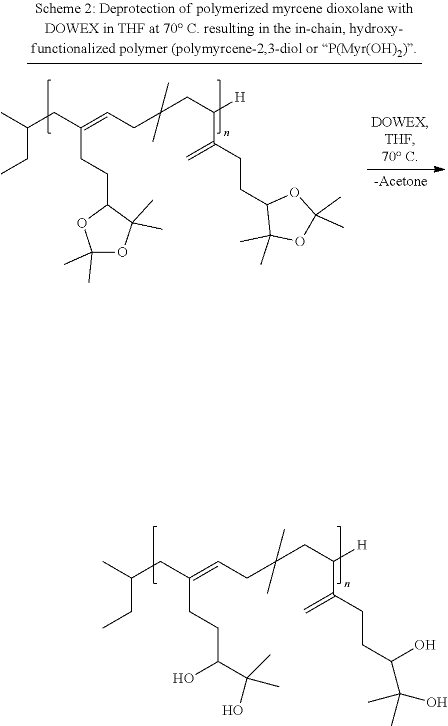

After the acidic treatment of the dioxolane-functionalized polymer with the deprotecting agent, a shift of the molecular weight distributions to higher elution volume was observed indicating a reduction of molecular weight caused by the removal of the acetal groups. Removal of the acetal groups also led to a slight broadening of the molecular weight distribution (MW/Mn). The conversion to hydroxy-functionalized myrcene-copolymers was confirmed by ¹H-NMR spectroscopy (600 MHz, C₆D₁₂, 25° C.), showing a shift of the two methyl signals of the dioxolane-functionalized myrcene monomer from 1.24 ppm and 1.10 ppm to 1.18 and 1.09 respectively, and by the disappearance of the two methyl signals 1.42 ppm and 1.33 ppm of the acetonide protecting group. The NMR-spectrum was measured after a purification step via preparative GPC in chloroform to remove undesired impurities resulting from the deprotection. The polymer data of the resulting hydroxy-functionalized copolymers are summarized in table 4.

TABLE 4
Conversion of the X-functionalized copolymers of
examples 8 and 9 into Y-functionalized polymers.

| Example No | Copolymer | Mn/kgmol⁻¹ | Mw/Mn |
|---|---|---|---|
| 8 | Copolymer of Ex 4 | 5.7 | 1.15 |
| | (styrene- | | |
| | comonomer) | | |
| 9 | Comonomer of Ex 5 | 4.5 | 1.16 |
| | (myrcene- | | |
| | comonomer) | | |

^{a} = SEC calibrated with polystyrene,
^{b} = SEC calibrated with polyisoprene.

1. A process of making a functionalized polymer comprising subjecting a functionalized diene monomer to at least one polymerization reaction to produce a functionalized polymer wherein the functionalized diene monomer is selected from the group according to formulae (1) to (3) 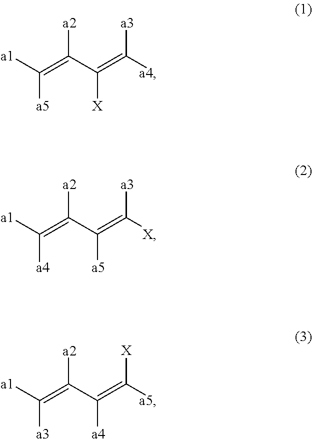
or a combination thereof, wherein a1, a2, a3, a4, a5 independently from each other represent either H or a saturated, unsaturated, linear or branched aliphatic hydrocarbon residue having from 1 to 12 carbon atoms, with the proviso that at least three of a1, a2, a3, a4 and a5 represent H, and wherein X represents a side group according to formula (4): 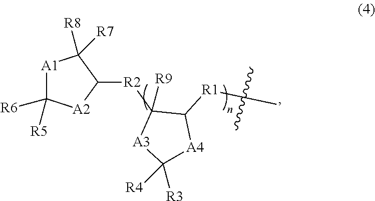
wherein in formula (4)
n is selected from 0, 1, 2, 3, 4, 5, 6, 7, 8, 9 or 10,
A1, A2, A3, A4 are identical or different and represent oxygen or —NR¹⁰R¹¹ wherein R¹⁰ and R¹¹ are identical or different and represent a C₁-C₁₂ alkyl residue or an aromatic residue with 6 to 20 carbon atoms selected from aryl, alkylaryl or arylalkyl, and wherein at least one of A1 or A2 and at least one of A3 or A4 represents oxygen,
R1 and R2 are identical or different and represent saturated or unsaturated, linear or branched divalent alkylenes containing from 1 and up to 20 carbon atoms;
R3, R4, R5, R6 are identical or different and represent H, a saturated, linear or branched aliphatic hydrocarbon with 1 to 10 carbon atoms which may contain one or more heteroatoms selected from N, S or O, or an aromatic residue which may contain one or more heteroatoms selected from N, S or O and contains from 5 and up to 20 carbon atoms;
R7, R8, R9 are identical or different and represent H, a linear or branched, saturated or unsaturated aliphatic, preferably alkyl, residue containing from 1 and up to 20 carbon atoms, and wherein the functionalized polymer comprises one or more groups X according to formula (4),
and wherein the process, optionally, further comprises converting at least some of the groups X of the polymer to groups Y according to formula (5), 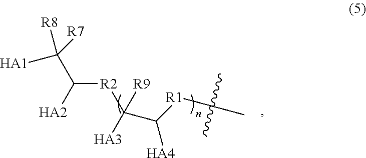
wherein in formula (5) n, R1, R2, R7, R8, R9, A1, A2, A3 and A4 have the same meaning as defined in formula (4).

2. The process of claim 1 wherein the at least one polymerization reaction comprises a copolymerization of at least one additional diene monomer, at least one vinylaromatic monomer or a combination thereof, wherein the at least one additional diene monomer is selected from the group consisting of 1,3-butadiene, isoprene, 1,3-pentadiene, 2,3-dimethylbutadiene, 1-phenyl-1,3-butadiene, 1,3-hexadiene and combinations thereof and wherein the at least one vinyl aromatic monomer is selected from the group consisting of styrene, ortho-methyl styrene, meta-methyl styrene, para-methyl styrene, para-tertbutyl styrene, vinyl naphthalene, divinyl benzene, trivinyl benzene, divinyl naphthalene and combinations thereof.

3. The process of claim 1 wherein in formula (4) A1, A2, A3 and A4 all represent an oxygen atom, R1 and R2 are identical or different and represent saturated or unsaturated divalent, linear or branched alkylenes containing from 1 and up to 10 carbon atoms, and n is selected from 0, 1 or 2.

4. The process of claim 1 wherein the diene monomer is selected from the group represented by formulae (6) to (9) or a combination thereof:

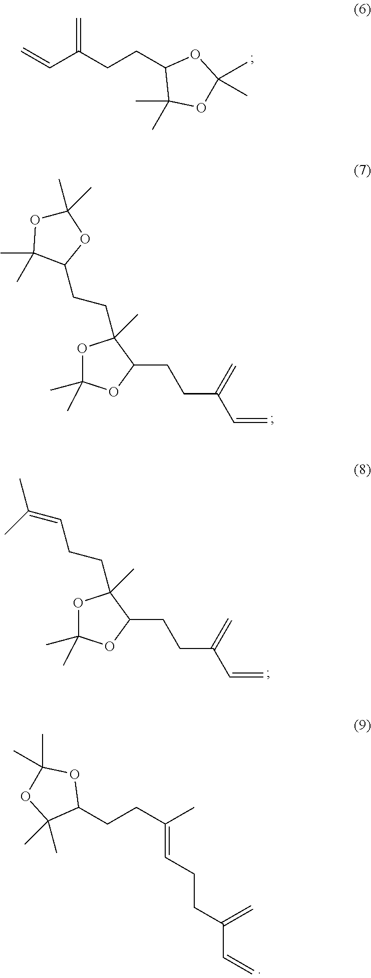

5. The process of claim 1 wherein the polymerization comprises anionic polymerization, radical polymerization, catalytic polymerization, or a combination thereof.

6. The process of claim 1 wherein the polymer has a glass transition temperature determined by differential scanning calorimetry of less than 20° C.

7. The process of claim 1 wherein the at least one polymerization reaction comprises a copolymerization to produce a copolymer comprising from 0.01% to 10% by weight based on the total weight of the polymer of units derived from one or more of the functionalized diene monomers and wherein the copolymer contains units derived from the one or more functionalized diene monomers or combinations thereof at the head position of the copolymer, the tail position of the copolymer or both at the head and at the tail position of copolymer.

8. A composition comprising a polymer having units according to formula (2-1) to (2-4) and (10) to (14) or a combination thereof: 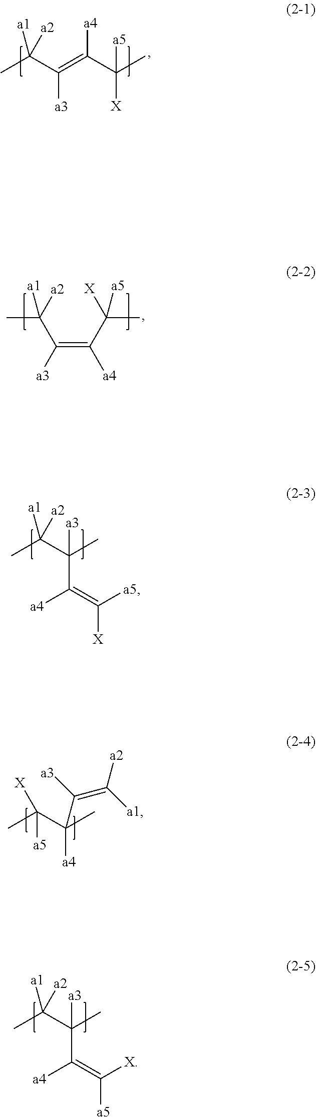 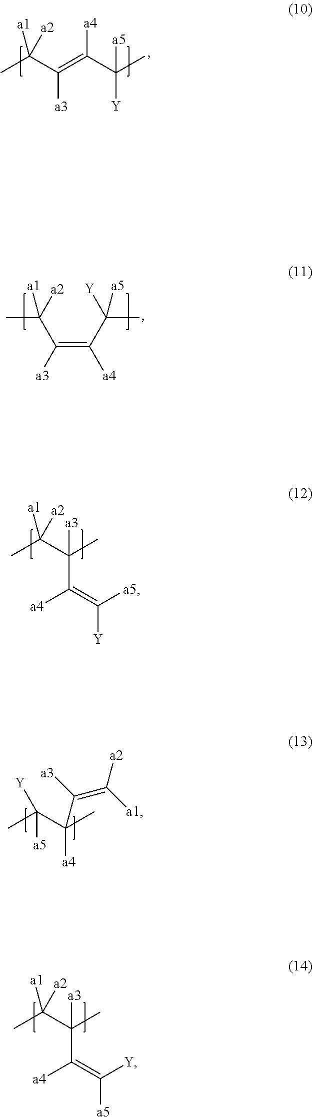
wherein a1, a2, a3, a4 and a5 have the same meaning as defined in claim 1 and wherein X represents a group according to formula (4): 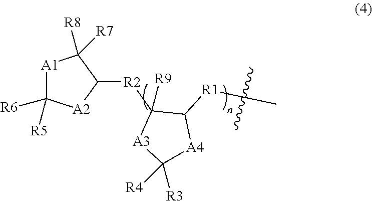
and wherein Y represents a group according to formula (5): 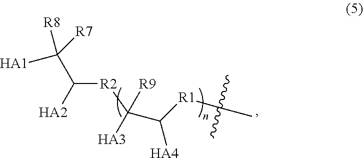
wherein in formula (4) or (5) n, A1, A2, A3, A4, R1, R2, R3, R4, R5, R6, R7, R8 and R9 have the same meaning as in claim 1.

9. The composition of claim 8 wherein in formula (4) and (5) A1, A2, A3 and A4 all represent an oxygen atom, R1 and R2 are identical or different and represent saturated or unsaturated divalent, linear or branched alkylenes containing from 1 and up to 10 carbon atoms, and n is selected from 0, 1 or 2.

10. The composition of claim 8 wherein the group Y is represented by formulae (15)-(19):

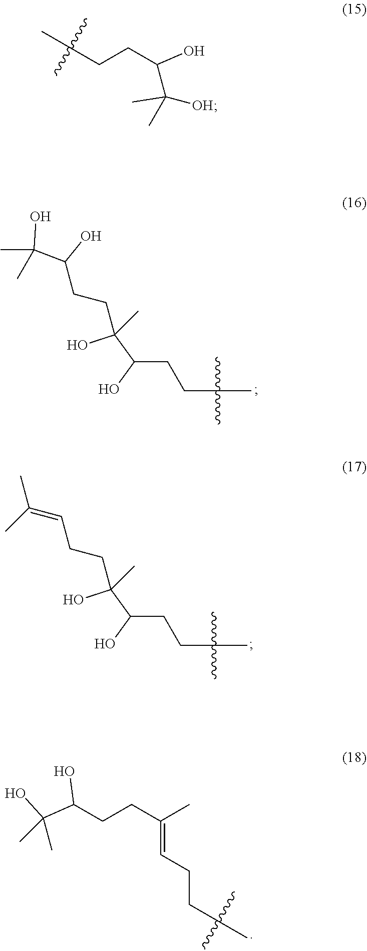

11. The composition according to claim 8 wherein the polymer is a copolymer and further comprises units derived from at least one additional diene monomer or at least one vinyl aromatic monomer or a combination thereof, wherein the at least one additional diene monomer is selected from the group consisting of 1,3-butadiene, isoprene, 1,3-pentadiene, 2,3-dimethylbutadiene, 1-phenyl-1,3-butadiene, 1,3-hexadiene and combinations thereof and wherein the at least one vinyl aromatic monomer is selected from the group consisting of styrene, ortho-methyl styrene, meta-methyl styrene, para-methyl styrene, para-tertbutyl styrene, vinyl naphthalene, divinyl benzene, trivinyl benzene, divinyl naphthalene and combinations thereof, and wherein the copolymer comprises from 0.01% to 10% by weight based on the total weight of the polymer of units according to formulae formula (2-1) to (2-4), (10) to (14) or a combination thereof, and these units are situated at the head position, at the tail position, or both at the head and at the tail position of copolymer.

12. The composition according to wherein the polymer has a glass transition temperature determined by differential scanning calorimetry of less than 20° C.

13. The composition according to claim 8, wherein the polymer is obtained by the process of claim 1.

14. An article comprising the reaction product of at least one curing reaction of a composition comprising at least one curing agent and the composition according to claim 8.

15. Method of making an article comprising subjecting a composition comprising the composition according to claim 8 and at least one curing agent to at least one curing reaction wherein the method further comprises at least one shaping step wherein the at least one shaping step can take place before, during or after the curing reaction.
